(19) United States
(12) Patent Application Publication
(10) Pub. No.: US 2008/0186307 A1
(43) Pub. Date: Aug. 7, 2008

(54) METHOD AND A PROTOCOL FOR DESCRIBING PROCEDURAL CONTENT FOR GAMES

(76) Inventor: Yaron Leifenberg, Rishon Lezion (IL)

Correspondence Address: Naomi Assia Law Offices;C/O Landon IP Inc., Suite 450, 1700 Diagonal Road, Alexandria, VA, 22314, US

(21) Appl. No.: 12/025,860

(22) Filed: Feb. 5, 2008

Related U.S. Application Data
(60) Provisional application No. 60/888,104, filed on Feb. 5, 2007.

(51) Int. Cl. G06T 15/00

(52) U.S. Cl. 345/419

(57) ABSTRACT

A method for producing procedural content for games having a plurality of nodes. The method includes defining a layer of abstraction in the form the plurality of nodes in a root-parent-child tree for creating a fluid data structure that can be interpreted at build time by predefined parameters. The method also includes implementing each of the plurality of nodes in a scenic graph as a specific building block and producing by the abstraction layer of a different 3-dimensional scenic graph for each instantiation, such that each instantiation may vary in basics including at least one of scale, translation, rotation and instancing, wherein the parameters are defined in ranges and can relate to at least one of scalar numbers and parent properties.

### CROSS-REFERENCE TO RELATED APPLICATION

This application claims priority from U.S. Provisional Patent Application No. 60/888,104, filed Feb. 5, 2007, which is hereby incorporated by reference in its entirety.

### FIELD OF THE INVENTION

The present invention generally relates to game content, and more particularly the present invention relates to a method and protocol for describing and illustrating procedural content for games.

### BACKGROUND OF THE INVENTION

Video games provide entertainment for a growing community of players. What makes a game entertaining typically depends on the preferences of the individual player. There are a number of different game genres, with each genre appealing to some players and not others. Examples of game genres include real-time strategy (RTS), first-person shooter (FPS) games, and role-playing games (RPG). Players who prefer to play with and against many other players are typically drawn to massively multiplayer online games (MMOG's).

MMOG's typically contain one virtual world in which all of the players participate. One problem with MMOG's is that a large amount of data is involved in keeping the virtual worlds up-to-date with all of the player transactions and their effects on the virtual world. This requires a large investment in computer resources such as storage space and server connections. For example, a MMOG may need to provide each player with a simultaneous connection to the server. As the number of players grows, so does the load on the server. Similarly, as the players add things such as enhanced abilities and/or items to their characters and to their worlds, the amount of storage space required to track all of the changes increases over time, and eventually becomes prohibitively expensive.

Some players prefer to play on their own computer or game console rather than compete against other people. Simulated life games provide a game experience where the player can develop a virtual world in which his or her characters can live and work. The Sims™. video game is an example of such a game. In the Sims™ video game players spend countless hours developing characters, buildings, lots and stories for their game. An entire community has been built up around the game. Dedicated fan Web sites provide a forum for sharing game content. A player can develop a character and manually upload it to a web site so that other players can see it and download it into their own games. Some players even specialize in creating specific kinds of content. For example, a player might be known for creating certain kinds of houses. Player-defined content such as this makes the game more interesting, but it can be somewhat inconvenient for a player to incorporate this player-defined content into his or her game. The player must first find suitable player-defined content, which requires the player to stop playing the game to search and download content, such as by browsing web servers or other servers for content. Furthermore, once the player finds the content, the content must be downloaded and manually integrated into the player's game. This process can be both time consuming and inconvenient. Thus, what is required is a video game that enhances the player experience with interesting game play by providing an enhanced player community experience by providing a convenient system and method to allow players to create and share game content with other players.

In U.S. Pat. Applic. No. 20030190591, Cheng discloses intellectual building blocks with cooperated game devices. The invention includes seventeen intellectual building blocks in different shapes assembled unequally by three to six units to make a planar or three-dimensional arrangement and combination to conduct the arrangement, as in a Russian block game through cooperating with a game frame disposed with three-dimensional paling rods and a guide slot. A three-dimensional pyramid is arranged through cooperating with a triangular game tray or to arrange different planar patterns through cooperating with a planar game tray so as to achieve the intellectual and edutainment effect.

In U.S. Pat. Applic. No. 20070245400, Paek, et al, teach a video description system and method. The application describes video content establishing video description records which include an object set, an object hierarchy and entity relation graphs. Video objects can include global objects, segment objects and local objects. The video objects are further defined by a number of features organized in classes, which in turn are further defined by a number of feature descriptors. The relationships between and among the objects in the object set are defined by the object hierarchy and entity relation graphs. The video description records provide a standard vehicle for describing the content and context of video information for subsequent access and processing by computer applications such as search engines, filters and archive systems.

U.S. Pat. Applic. No. 20070035558, by Benayon, et al, teaches Visual model importation. Embodiments of the invention address deficiencies of the art with respect to modeling a process having a visual representation and provide a method, system and computer program product for importing a visual representation of a process for use in an application. In one embodiment, a computer-implemented visual process model importation method can include identifying an arrangement of one or more visual objects in a visual process model, selecting associations between the visual objects and corresponding representative elements for a target process model, mapping the visual objects in the source model into the selected corresponding representative elements for the target process model, and producing the target process model for the visual process model using the mapping. The method subsequently can include providing the target process model as input to an application such as a simulation engine, a workflow engine or a visual collaboration and documentation system.

FIG. 1a is a prior art schematic flow diagram of procedural content creation. An artist 110 uses a computer to manually create exemplary content 115. Content 115 is a 3D image of a building, which may be intended as part of a city for a video game. A video game designer 120 manually places content 115 in the game scene 125. This process is repeated for every building and every other feature of game scene 125, such as cars, trees, people, etc. Weeks and months are needed to generate the results.

Thus, it would be advantageous to have an improved method for populating the procedural content of video scenes and giving an interface for artists and content creators to easily define and structure procedural content in hours instead of weeks, with vastly richer diversity.

### SUMMARY OF THE INVENTION

Accordingly, it is a principal object of the present invention to provide a method and protocol for describing and illustrating procedural content for games.

It is another principal object of the present invention to provide an interface for artists and content creators to easily define and structure procedural content.

It is yet another principal object of the present invention to provide an abstraction layer that produces a different 3-dimensional scenic graph for each instantiation.

It is one other principal object of the present invention to provide a new robust approach to structure definition for procedural content for games.

It is one more principal object of the present invention to provide structure definition for procedural content for games in hours instead of weeks.

It is one further principal object of the present invention to provide structure definition for procedural content for games with vastly more variation.

A method is disclosed for producing procedural content for games having a plurality of nodes. The method includes defining a layer of abstraction in the form the plurality of nodes in a root-parent-child tree for creating a fluid data structure that can be interpreted at build time by predefined parameters. The method also includes implementing each of the plurality of nodes in a scenic graph as a specific building block and producing by the abstraction layer of a different 3-dimensional scenic graph for each instantiation, such that each instantiation may vary in basics including at least one of scale, translation, rotation and instancing, wherein the parameters are defined in ranges and can relate to at least one of scalar numbers and parent properties.

The present invention provides a method and protocol for describing and illustrating procedural content for games. A layer of abstraction is defined for creating a fluid data structure that can be interpreted at build time by predefined parameters. The abstraction layer produces a different 3-dimensional scenic graph for each instantiation relative to nodes that may or may not appear. Each instantiation may vary in basics such as scale, translation or rotation and instancing. The parameters are defined in ranges, and can relate to scalar numbers or to parent properties. Each node in the scenic graph is then implemented as a specific building block, which defines its own visualization and functionality. The building blocks range from visual effects to physical effects, such as objects that can block or restrain movement.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

In order to understand the invention and to see how it may be carried out in practice, a preferred embodiment will now be described, by way of a non-limiting example only, with reference to the accompanying drawings, in which:

FIG. 1a is a prior art schematic flow diagram of procedural content creation;

FIG. 1b is a schematic flow diagram of procedural content creation, constructed according to the principles of the present invention;

FIG. 2 is a diagrammatic representation of a basic definition of the protocol, constructed according to the principles of the present invention;

FIG. 3 is a diagrammatic representation of an exemplary instance of the protocol of the present invention, constructed according to the principles of the present invention;

FIG. 4 is an exemplary schematic illustration of procedural content in the form of a city layout, constructed according to the principles of the present invention; and

FIG. 5 is another exemplary schematic illustration of procedural content in the form of a city layout, constructed according to the principles of the present invention.

### DETAILED DESCRIPTION OF AN EXEMPLARY EMBODIMENT

The principles and operation of a method and an apparatus according to the present invention may be better understood with reference to the drawings and the accompanying description, it being understood that these drawings are given for illustrative purposes only and are not meant to be limiting.

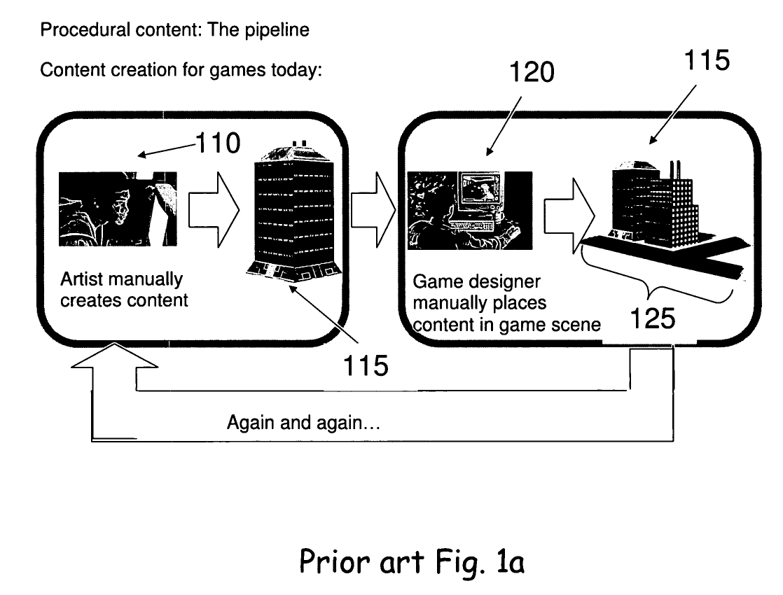

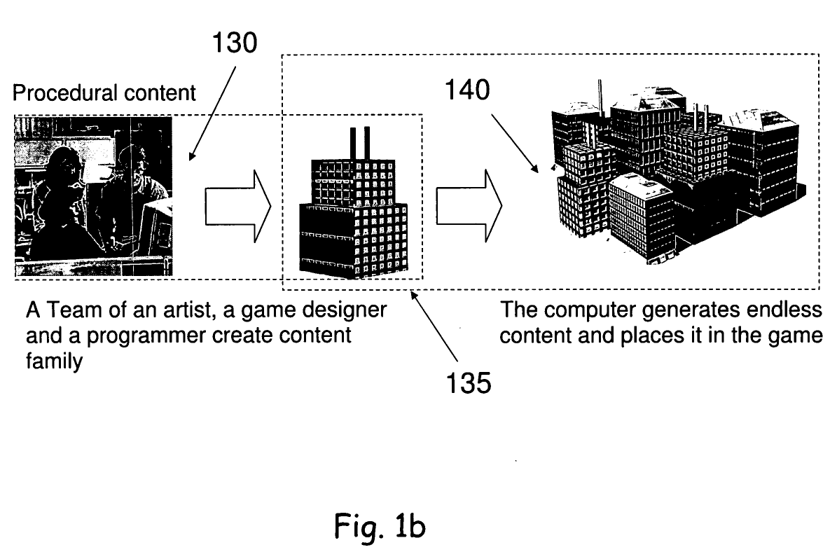

FIG. 1b is a schematic flow diagram of exemplary procedural content creation, constructed according to the principles of the present invention. A team of an artist, a game designer and a programmer use a computer and an XML file, for example, to create a content family 130. The exemplary content in this instance is a building 135. The computer generates endless content and places it in the game.

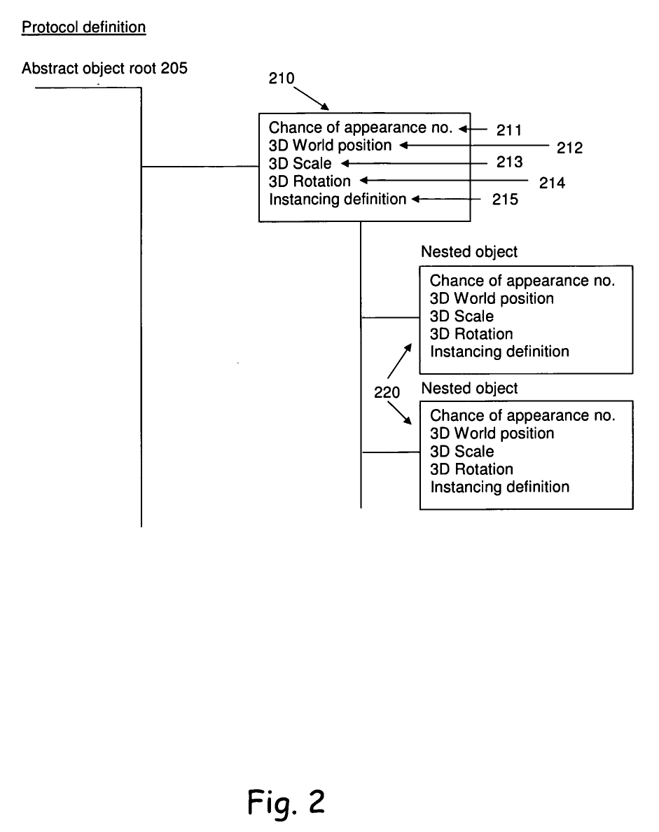

FIG. 2 is a diagrammatic representation of a basic definition of the protocol of the present invention, constructed according to the principles of the present invention. An inverted tree structure of nodes in the form of parent-child nesting is used to represent an object such as buildings, cars, people, trees or chairs, for example. The protocol definition shows an abstract object root 205. Each object root may be expressed in terms of one or more features 210 each having ranges for a corresponding set of definitions. Each feature 210 for the object may have one or more nested objects 220. Each feature 210 has a chance of appearance no. 211, a 3D World position 212, a 3D Scale 213, a 3D Rotation 214 and an Instancing definition 215.

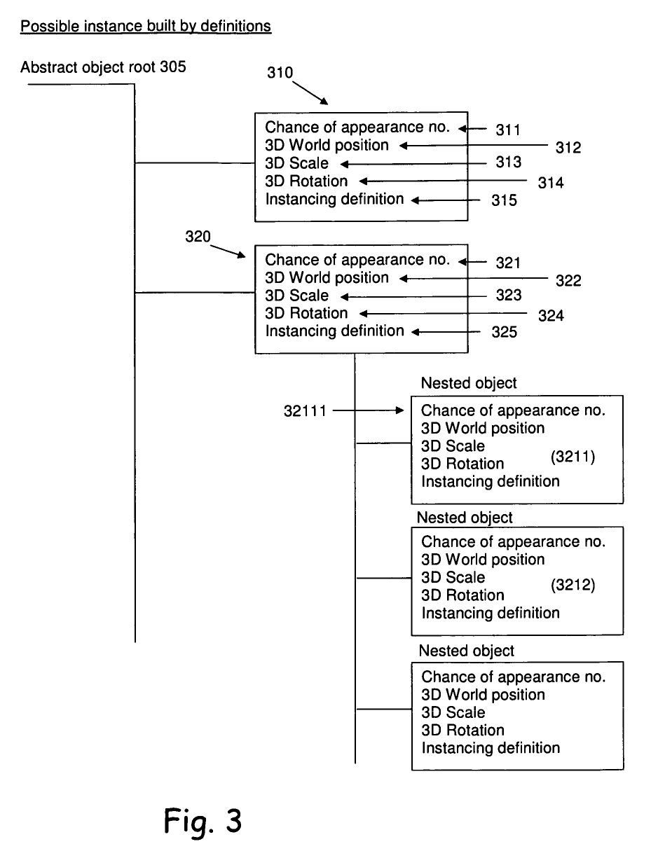

FIG. 3 is a diagrammatic representation of an exemplary instance of the protocol of the present invention, constructed according to the principles of the present invention. The exemplary implementation shows an expansion of the protocol definition of FIG. 2.

Feature 310 for the buildings may be the basic shape, which is the instancing definition 315. If the number of possible shapes is 2, i.e., a rectangular shape (1) or a cylindrical shape (2), then the chance of appearance number 311 (range) is 2. For a particular nested object, the chance of appearance number is 1 or 2. Ranges for each of the definitions may be an absolute number or a measurement range, such as the width and/or length of a floor in meters, for example. Thus an artist can have an enormous influence over the look and feel of a video game city, simply by tweaking these ranges, and then have the computer generate or regenerate the 3D city at random within those ranges.

A second feature 320 for the buildings object would be an instancing definition of “floors” 325. The number of floors can be one or a hundred, for example. In general the chance of appearance 321 is random, so if the range of “floors” is 100 then the chance of appearance (range) 321 is 100. For each floor there are also such features as “windows” 3211 which would also have a set number of appearances 32111.

Windows from floor to floor may vary little, but “air conditioners,” an exemplary nested (child) of “floors,” may vary between instances. Thus, the instancing definition 325, for example, defines whether this feature is the same for each instance or not. The instancing definition can define whether the nested feature inherits a feature from the parent, or there is an added level of randomization. For example the floors may all be the size of the parent building or there may be a series of contractions of size every ten floors up. Each group of the same size would belong to a different nested member in series of child floor elements belonging to the same parent.

The 3D world position 312 and 322 defines limitations of the surroundings. Thus, in a rural area chance of appearance (range) 321 for floors is likely to be smaller and in a metropolis it is likely to be larger. Also, the position of the entrance 3212 could be limited by the position of the building on a block in a large city. For example, the south side of a block would most likely have buildings with south-facing entrances. This would be factored in by 3D world position 322, for example.

3D scale 313 and 323, for example, is a form of randomizing feature. E.g., identical instantiations of a building can thus be further differentiated by application of a range of 20 or 30 scales: 20:1, 21:1, 22:1 . . . 30:1, especially if features, sub-features, sub-sub-features, etc, are all varied by scale.

3D rotation 314 and 324 is a polar coordinate, where the object is oriented according to angular displacement.

A third feature for the buildings object would be an instancing definition of “entrance type,” for example, canopied, revolving door, security entrance, delivery entrance, etc.

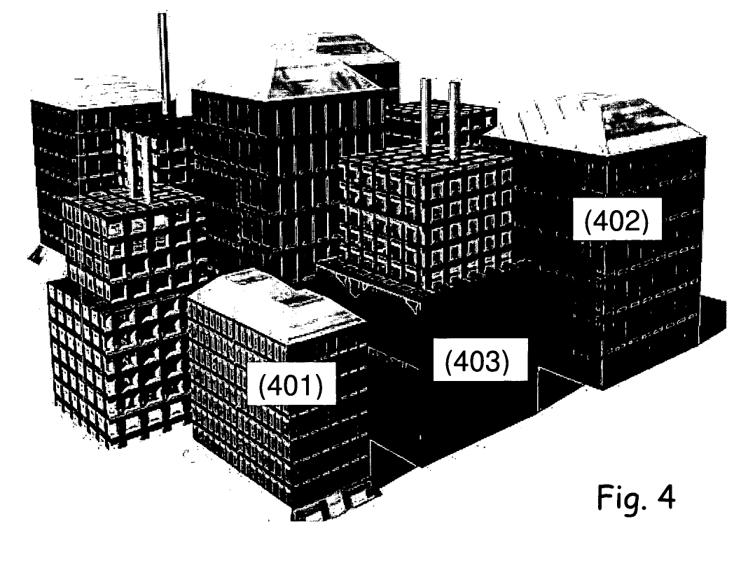

FIG. 4 is an exemplary schematic illustration of procedural content in the form of a city layout, constructed according to the principles of the present invention. Several buildings, 401 and 402 for example, are identical except for scale and number of floors. The floor size and window style may change at a particular point of height within a building 403. Roof styles may vary, as between buildings 402 and 403.

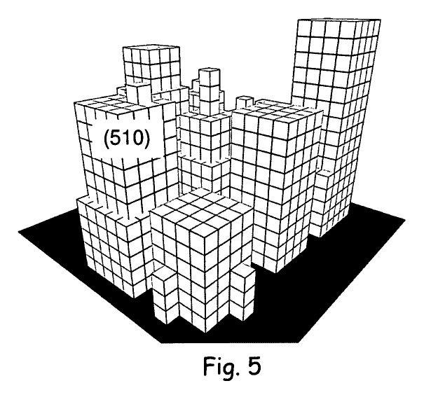

FIG. 5 is another exemplary schematic illustration of procedural content in the form of a city layout, constructed according to the principles of the present invention. No two buildings are identical 510.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

We claim:

1. A method for producing procedural content for games having a plurality of nodes, said method comprising:
defining a layer of abstraction in the form the plurality of nodes in a root-parent-child tree for creating a fluid data structure that can be interpreted at build time by predefined parameters;
implementing each of the plurality of nodes in a scenic graph as a specific building block; and
producing by the abstraction layer of a different 3-dimensional scenic graph for each instantiation,
such that each instantiation may vary in basics comprising at least one of scale, translation, rotation and instancing, wherein the parameters are defined in ranges and can relate to at least one of scalar numbers and parent properties.

2. The method of claim 1, wherein each node defines its own functionality.

3. The method of claim 1, wherein each node defines its own visualization.

4. The method of claim 1, wherein the building blocks range from visual effects to physical effects.

5. The method of claim 4, wherein said physical effects comprise at least the blocking of movements.

6. The method of claim 4, wherein said physical effects comprise at least the restraining of movements.

7. The method of claim 1, wherein a team comprising at least one artist, at least one game designer and at least one programmer use a computer and an XML file to create a content family.

8. The method of claim 7, wherein said computer generates a vast array of content and places it in the game.

9. The method of claim 1, wherein each node comprises a plurality of features comprising at least one of a chance of appearance number, a 3 Dimensional (3D) world position, a 3D scale, a 3D rotation and an instancing definition.

10. A protocol for producing procedural content for games having a plurality of nodes, said protocol comprising:
defining a layer of abstraction in the form the plurality of nodes in a root-parent-child tree for creating a fluid data structure that can be interpreted at build time by predefined parameters;
implementing each of the plurality of nodes in the scenic graph as a specific building block; and
producing by the abstraction layer of a different 3-dimensional scenic graph for each instantiation,
such that each instantiation may vary in basics comprising at least one of scale, translation, rotation and instancing, wherein the parameters are defined in ranges, and can relate to at least one of scalar numbers and parent properties.
